(19) United States
(12) Patent Application Publication
(10) Pub. No.: US 2008/0301814 A1
(43) Pub. Date: Dec. 4, 2008

(54) Information processing apparatus, information processing method, and computer-readable recording medium storing information processing program

(75) Inventor: Hisanori Takahashi, Chiba (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/155,290

(22) Filed: Jun. 2, 2008

(30) Foreign Application Priority Data
Jun. 4, 2007 (JP) 2007-148430

(51) Int. Cl. G06F 21/00

(52) U.S. Cl. 726/25

(57) ABSTRACT

An information processing apparatus is disclosed. The information processing apparatus includes a table which describes a relationship between security strength (for example, HIGH, MIDDLE, or LOW) of a computer system of the information processing apparatus and values (for example, ON or OFF) of security function items that stipulate security functions in the information processing apparatus. When a user designates to change the security strength on a screen, the values of the security function items are changed based on the changed security strength. The changed values of the security function items are reported to the user on another screen.

### BACKGROUND OF THE INVENTION

1. Field of the Invention

The present invention generally relates to an information processing apparatus, an information processing method, and a computer-readable recording medium storing an information processing program.

2. Description of the Related Art

In an information processing apparatus having functions to apply processes to image data, for example, an MFP (multifunctional peripheral), high-degree settings can be determined for the functions of, for example, security management and user authentication.

In Patent Document 1, a security database server is disclosed in which a system manager can totally manage and change a security policy of an apparatus including an MFP. In the server, security function operations can be changed by changing a security function item.

[Patent Document 1] Japanese Laid-Open Patent Application No. 2006-253845

However, in Patent Document 1, the security strength of the total system must be determined by comprehensively considering reactions when security function items are changed. Consequently, it takes a long time for the system manager to determine the security strength by considering the reactions from the changed security function items. In addition, since the security strength of the total system must be determined to satisfy the policy of the organization of the system, when the system manager determines the security strength of the total system by considering each of the security function items, the security strength of the total system may not satisfy the policy due to the individual consideration.

In addition, in order to expand the existing security function items of the system, when a new security function item is added to an information processing apparatus by installing a plug-in program, an existing program must be revised.

### SUMMARY OF THE INVENTION

In a preferred embodiment of the present invention, there is provided an information processing apparatus, an information processing method, and a computer-readable recording medium storing an information processing program, in which values (ON and OFF) of security function items can be easily changed when a user designates to change security strength of a computer system of the information processing apparatus.

In addition, in the information processing apparatus, the information processing method, and the computer-readable recording medium storing the information processing program, when a new component having a new security function item is added to the computer system of the information processing apparatus, a value of the new security function item can be easily set in the computer system based on the designated security strength without changing an existing program (software); further, the values of the security function items can be easily changed when the security strength is designated without changing the existing program (software).

Features and advantages of the present invention are set forth in the description that follows, and in part will become apparent from the description and the accompanying drawings, or may be learned by practice of the invention according to the teachings provided in the description. Features and advantages of the present invention may be realized and attained by an information processing apparatus, an information processing method, and a computer-readable recording medium storing an information processing program particularly pointed out in the specification in such full, clear, concise, and exact terms so as to enable a person having ordinary skill in the art to practice the invention.

To achieve one or more of these and other advantages, according to one aspect of the present invention, there is provided an information processing apparatus. The information processing apparatus includes a defining unit which defines a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system, a security strength change receiving unit which receives a change of the security strength step by step, and a first value changing unit which changes a value of a security function item of a component by referring to the relationship defined by the defining unit when the security strength change receiving unit receives the change of the security strength.

According to another aspect of the present invention, there is provided an information processing method in an information processing apparatus. The information processing method includes the steps of defining a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system, receiving a change of the security strength step by step and changing a value of a security function item of a component by referring to the relationship when the change of the security strength is received.

According to another aspect of the present invention, there is provided a computer-readable recording medium storing an information processing program in an information processing apparatus. The information processing program executes the steps of defining a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system, receiving a change of the security strength step by step, and changing a value of a security function item of a component by referring to the relationship when the change of the security strength is received.

### EFFECT OF THE INVENTION

According to an embodiment of the present invention, an information processing apparatus includes a defining unit which defines a relationship between security strength of a computer system of the information processing apparatus and values of security function items of corresponding components. The values of the security function items are changed when the security strength is changed by referring to the defined relationship. Therefore, when a user designates security strength of the computer system, the values of the security function items can be simply changed.

In addition, the information processing apparatus further includes a plug-in program installing unit which installs a plug-in program of a new component for adding a new security function item to the information processing apparatus, and the component includes information of a relationship between the security strength of the computer system and a value of the new security function item of the component. Therefore, when a user installs a new component having a new security function item, the new component having the new security function item can be easily installed into the computer system of the information processing apparatus without changing an existing program. Further, when the user changes the security strength of the computer system, the value of the new security function item can be easily changed by referring to the relationship.

### BRIEF DESCRIPTION OF THE DRAWINGS

Features and advantages of the present invention will become more apparent from the following detailed description when read in conjunction with the accompanying drawings, in which:

FIG. 1 is a diagram showing a hardware structure of an information processing apparatus according to an embodiment of the present invention;

FIG. 2 is a diagram showing the architecture for realizing security setting processes in the information processing apparatus according to the embodiment of the present invention;

FIG. 3 is a schematic diagram showing transition of UI screens in security settings in the information processing apparatus according to the embodiment of the present invention;

FIG. 4 is a first definition table which defines a relationship between security strength and security function items in the information processing apparatus according to the embodiment of the present invention;

FIG. 5 is a second definition table which defines another relationship between the security strength and the security function items in the information processing apparatus according to the embodiment of the present invention;

FIG. 6 is a sequence chart showing first processes in a security strength check in the information processing apparatus according to the embodiment of the present invention;

FIG. 7 is a first table which is used by a first security strength determining method in the information processing apparatus according to the embodiment of the present invention;

FIG. 8 is a second table which is used by a second security strength determining method in the information processing apparatus according to the embodiment of the present invention;

FIG. 9 is a third table which is used by a third security strength determining method in the information processing apparatus according to the embodiment of the present invention;

FIG. 10 is a fourth table which is used by a fourth security strength determining method in the information processing apparatus according to the embodiment of the present invention;

FIG. 11 is a sequence chart showing second processes in the security strength check in the information processing apparatus according to the embodiment of the present invention;

FIG. 12 is a sequence chart showing processes when the security strength is designated in the information processing apparatus according to the embodiment of the present invention;

FIG. 13 is a sequence chart showing processes when a value of user authentication is changed in the information processing apparatus according to the embodiment of the present invention;

FIG. 14 is a sequence chart showing processes when a new component having security function items is added to the information processing apparatus by installing a plug-in program according to the embodiment of the present invention;

FIG. 15 is a table which describes a relationship between the security strength and security function items having corresponding values of a new component according to the embodiment of the present invention;

FIG. 16 is a table showing a list of components having corresponding security function items in a setting change controlling component according to the embodiment of the present invention; and

FIG. 17 is a sequence chart modified from the sequence chart shown in FIG. 14 when a setting item defining component is added to the information processing apparatus according to the embodiment of the present invention.

### DESCRIPTION OF THE PREFERRED EMBODIMENT

### Best Mode of Carrying Out the Invention

The best mode of carrying out the present invention is described with reference to the accompanying drawings.

In an embodiment of the present invention, as an information processing apparatus, a digital multifunctional apparatus, for example, an MFP is used. The MFP includes an image copying function, a facsimile function of an image, an image printing function, an image scanning function, and an image delivering function which delivers an image read by the image scanning function, input by the facsimile function, and so on.

### [Hardware Structure of Information Processing Apparatus]

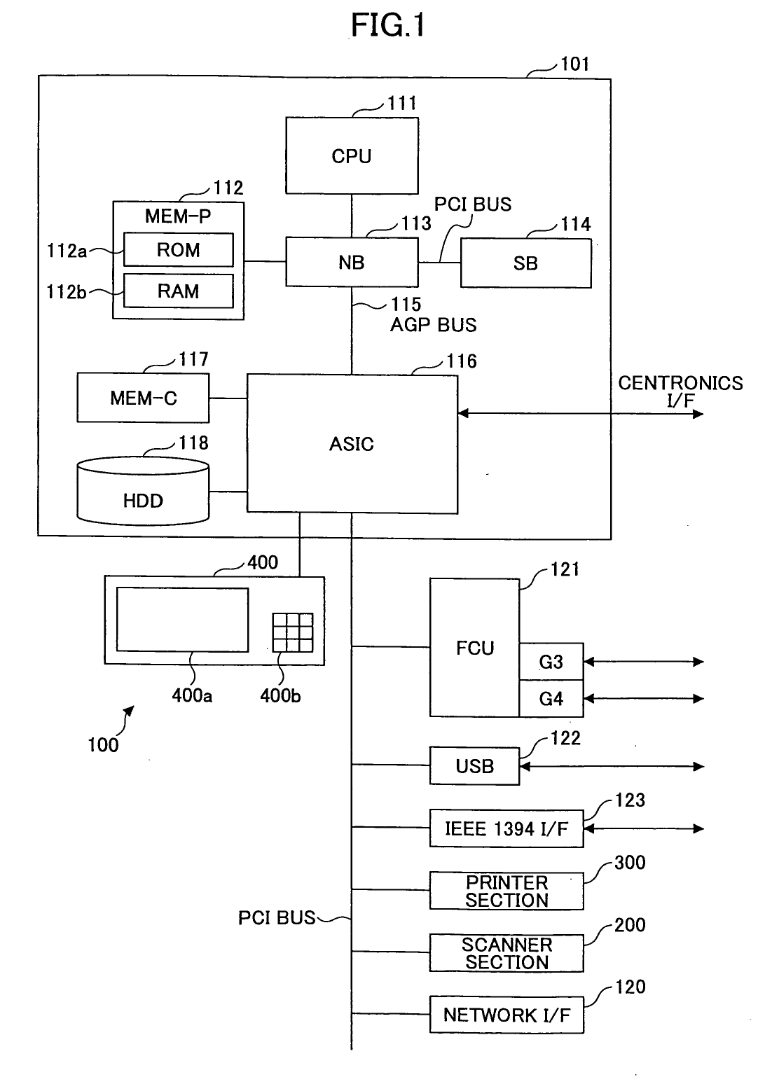

Referring to FIG. 1, a hardware structure of an information processing apparatus 100 according to the embodiment of the present invention is described.

FIG. 1 is a diagram showing the hardware structure of the information processing apparatus 100 according to the embodiment of the present invention.

As shown in FIG. 1, the information processing apparatus 100 (digital multifunctional apparatus) includes a controller 101, a scanner section 200, and a printer section 300. The controller 101 is connected to the scanner section 200 and the printer section 300 via a PCI (peripheral component interconnect) bus. The controller 101 controls all elements (operations) of the information processing apparatus 100.

The information processing apparatus 100 further includes an operating section 400, and the controller 101 controls input and output operations on the operating section 400. The scanner section 200 and the printer section 300 include corresponding image processing sections, for example, an error diffusion processing section and a gamma conversion processing section. The operating section 400 includes an operation displaying section 400a and a keyboard 400b, and the operation displaying section 400a receives an instruction from a user via a touch panel, and displays an operating status of the information processing apparatus 100. The operation displaying section 400a is, for example, an LCD (liquid crystal display) and further displays, for example, document image information read by the scanner section 200. The keyboard 400b receives an instruction from the user by key operations.

In the information processing apparatus 100, a document box function, a document copying function, a document printing function, and a document facsimile function can be selected by switching the functions in order by using an application switching key (not shown) on the operating section 400. The information processing apparatus 100 enters a document box mode when the document box function is selected, a document copying mode when the document copying function is selected, a document printing mode when the document printing function is selected, and a document facsimile mode when the document facsimile function is selected.

The controller 101 includes a CPU (central processing unit) 111, a system memory unit (MEM-P) 112, an NB (north bridge) 113, an SB (south bridge) 114, an ASIC (application specific integrated circuit) 116, a local memory unit (MEM-C) 117, and an HDD (hard disk drive) 118. The ASIC 116 is connected to the NB 113 via an AGP (accelerated graphic port) bus 115. The MEM-P 112 includes a ROM 112a and a RAM 112b.

The NB 113, the MEM-P 112, and the SB 114 form a chip set and the CPU 111 is connected to external devices (apparatuses) via the chip set.

The NB 113 connects the CPU 111 to the MEM-P 112, the SB 114, and the AGP bus 115. The NB 113 includes a memory controller for controlling reading and writing data from/to the MEM-P 112, a PCI master, and an AGP target.

The MEM-P 112 stores programs and data, for example, print data for the printer section 300. The ROM 112a stores the programs and the data for controlling operations of the CPU 111. The RAM 112b holds the program and the data when the program is being executed and the data are being processed, and stores data, for example, the print data for the printer section 300.

The SB 114 is connected to the NB 113 via the PCI bus, and a network I/F (interface) 120 is connected to the PCI bus.

The ASIC 116 is an image data processing IC and also works as a bridge which connects the AGP bus 115, the MEM-C 117, the HDD 118, and the PCI bus with each other.

The ASIC 116 includes a PCI target, an AGP master, an ARB (arbiter) which is a core of the ASIC 116, a memory controller for controlling the MEM-C 117, plural DMACs (direct memory access controllers) which execute, for example, rotation of image data by hardware logic, and a PCI unit for transferring data between the ASIC 116 and the printer section 300 and/or the scanner section 200 via the PCI bus. An FCU (facsimile control unit) 121, a USB (universal serial bus) 122, and an IEEE 1394 I/F are connected to the ASIC 116 via the PCI bus.

The MEM-C 117 is used as a buffer for storing copy image data and codes. The HDD 118 stores image data, a program for controlling the CPU 111, font data, and form (format) data.

The AGP bus 115 is used so that the ASIC 116 can access the MEM-P 112 with high throughput.

[Architecture for Security Setting Processes]

Next, security setting processes are described which processes are realized when the CPU 111 executes a program.

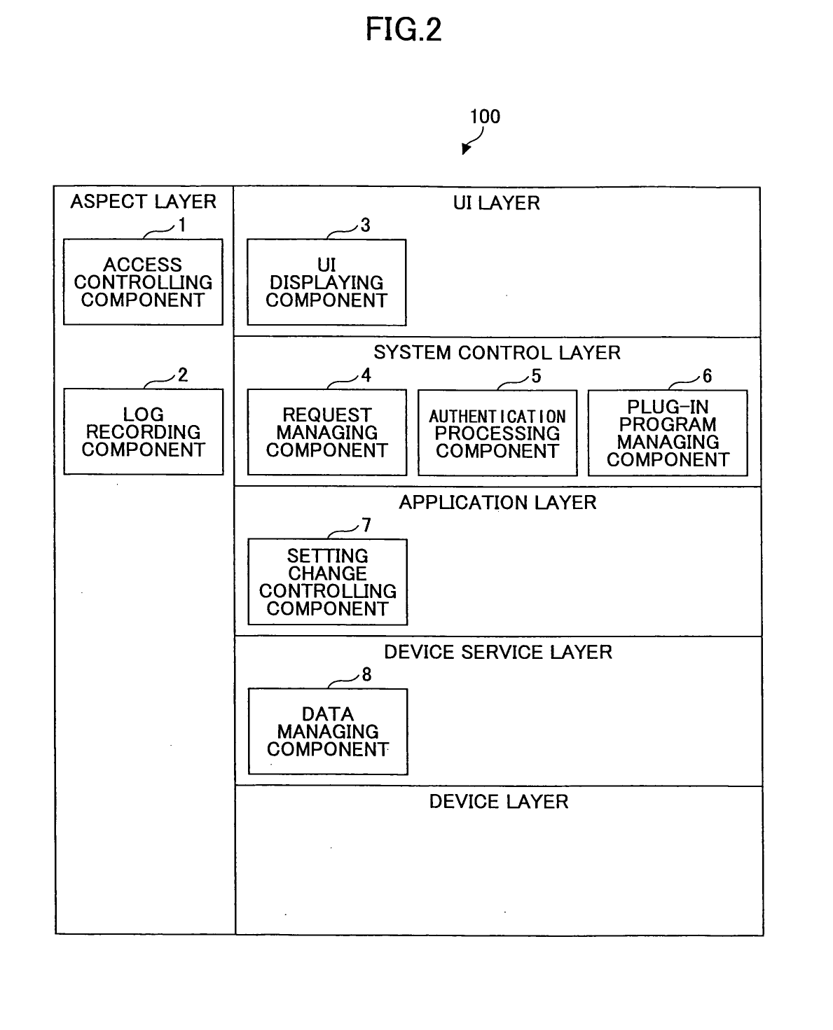

FIG. 2 is a diagram showing the architecture for realizing the security setting processes in the information processing apparatus 100 according to the embodiment of the present invention.

As shown in FIG. 2, in the information processing apparatus 100, when the CPU 111 executes a program, an access controlling component 1, a log recording component 2, a UI (user interface) displaying component 3, a request managing component 4, an authentication processing component 5, a plug-in program managing component 6, a setting change controlling component 7, and a data managing component 8 are realized.

As shown in FIG. 2, the above components 1 through 8 are in corresponding layers.

In FIG. 2, a UI layer works as a user interface in the computer system of the information processing apparatus 100. That is, the UI layer has a main role which provides a main screen for a user when the user accesses the information processing apparatus 100. In addition, the UI layer provides an application screen on the main screen when the user selects an application item; that is, the UI layer provides a function of the application item to the user.

A system control layer provides a scheme so that the total system is stably operated, and controls operations of the application item. Only control logic of the total system is in the system control layer without handling an application item individual matter. For example, job management and user authentication are handled in the system control layer.

An application layer contains each application item. In the architecture, addition, change, and/or deletion of an application item can be easily executed, and a new application item can be easily formed by combining existing application items.

A device service layer is utilized by the application layer. The device service layer provides a common service to each application item. There is a big difference between the system control layer and the device service layer. That is, the system control layer controls the application items; however, the device service layer is utilized by the application items. For example, a data managing module is in the device service layer.

A device layer drives devices in the system, provides an abstract device interface to the device service layer, and bridges differences among devices. At the same time, the device layer separates a device individual matter from a device common matter.

An aspect layer contains components such as the log recording component 2, which relates to the total system and is difficult to place in individual layers. The components in the aspect layer are designed differently from the other components.

As shown in FIG. 2, the access controlling component 1 and the log recording component 2 are in the aspect layer. The access controlling component 1 provides a security function item which controls an access right to the information processing apparatus 100. The log recording component 2 provides a security function item which records a log of the information processing apparatus 100. The security function item prevents or avoids vulnerability of the computer system of the information processing apparatus 100 and a threat from the outside to the computer system of the information processing apparatus 100.

The UI displaying component 3 is in the UI layer, causes the operation displaying section 400a of the operating section 400 to display a UI, and causes a user to communicate with the controller 101.

The request managing component 4, the authentication processing component 5, and the plug-in program managing component 6 are in the system control layer. The request managing component 4 manages a schedule of user processing requests. The authentication processing component 5 provides a security function item which authenticates a user.

The plug-in program managing component 6 controls installing/uninstalling security function components such as the access controlling component 1, the log recording component 2, and the authentication processing component 5 into the system of the information processing apparatus 100.

The setting change controlling component 7 is in the application layer. The setting change controlling component 7 controls changing a value of a security setting item in each security function component, for example, the access controlling component 1, the log recording component 2, and the authentication processing component 5, and determines the security strength of the system of the information processing apparatus 100. The value of the security function item stipulates behavior (ON or OFF) of the security function item, and the security strength is a degree of countermeasures against the vulnerability of the computer system or a degree of countermeasures against a threat from the outside to the system.

The data managing component 8 is in the device service layer and writes the values of the security function item in the HDD 118 and/or the MEM-C 117.

[Brief Description of Security Settings]

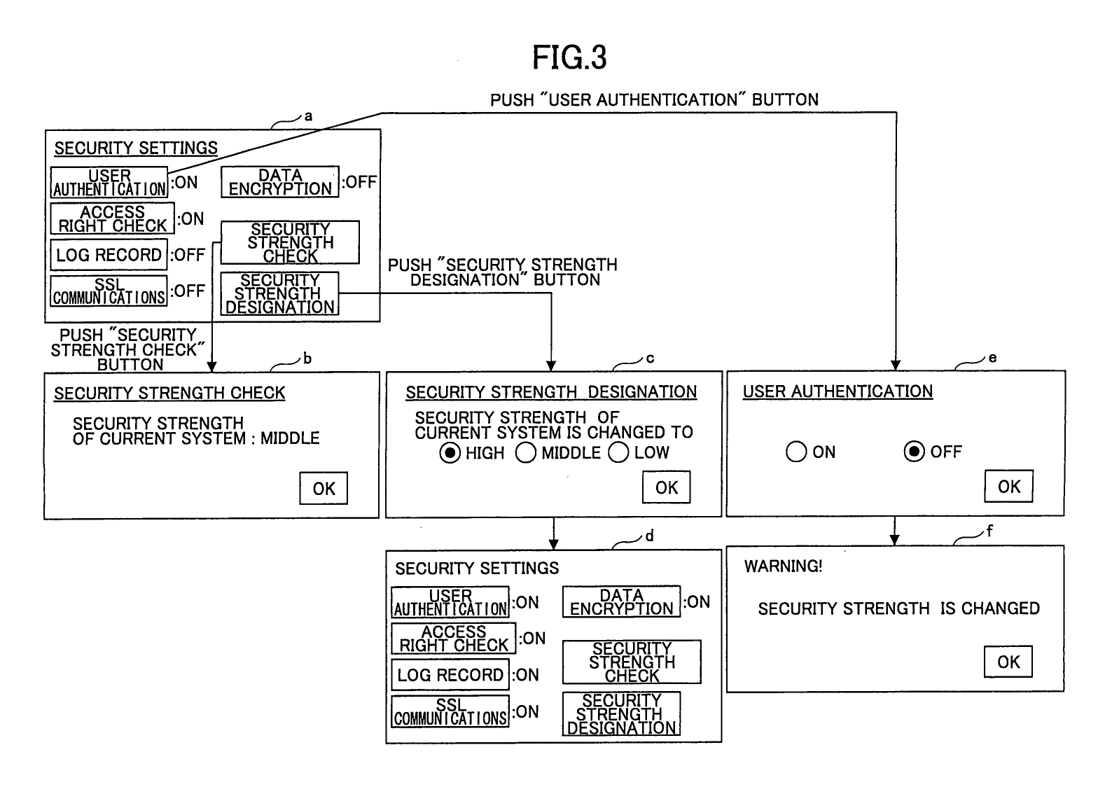

First, processes of security settings in the information processing apparatus 100 are briefly described based on transition of UI screens displayed on the operation displaying section 400a of the operating section 400. FIG. 3 is a schematic diagram showing the transition of the UI screens in the security settings.

In FIG. 3, “a” is a top screen in the security settings. In the top screen “a” of the security settings, buttons showing the corresponding security function items and corresponding setting statuses (values) of the buttons are displayed. That is, a “USER AUTHENTICATION” button, an “ACCESS RIGHT CHECK” button, a “LOG RECORD” button, an “SSL (secure socket layer) COMMUNICATIONS” button, and a “DATA ENCRYPTION” button are displayed. In addition, each value is ON or OFF.

The “USER AUTHENTICATION” button indicates whether a user is to be authenticated which authentication is executed by the authentication processing component 5. The “ACCESS RIGHT CHECK” button indicates whether the user is to have an access right which is checked by the access controlling component 1. The “LOG RECORD” button indicates whether a log record is to be executed which is executed by the log recording component 2. The “SSL COMMUNICATIONS” button indicates whether encryption communications are to be executed by the SSL. The “DATA ENCRYPTION” button indicates whether data are to be encrypted.

In addition, a “SECURITY STRENGTH CHECK” button, and a “SECURITY STRENGTH DESIGNATION” button are displayed on the top screen “a”. By pushing the “SECURITY STRENGTH CHECK” button, security strength of a current system is confirmed. The “SECURITY STRENGTH DESIGNATION” button indicates a change of the security strength of the current system.

When the user pushes (touches) the “SECURITY STRENGTH CHECK” button on the top screen “a”, a second screen “b” is displayed. In the second screen “b”, a security strength confirming and reporting unit is realized. In the second screen “b”, the security strength “MIDDLE” of the current system of the information processing apparatus 100 is displayed. Levels of the security strength can be displayed as, for example, “HIGH”, “MIDDLE”, or “LOW”. That is, “HIGH” shows that the security strength is high, “MIDDLE” shows that the security strength is middle, and “LOW” shows that the security strength is low. When the user pushes an “OK” button on the second screen “b”, the second screen “b” is changed to the top screen “a”.

The levels of the security strength are not limited to “HIGH”, “MIDDLE”, and “LOW”, and can be levels of “n” steps (n>3). In addition, the levels of the security strength can comply with IEEE P2600 which realizes security and confidentiality of a document in an office. Further, the user can determine the levels of the security strength by user own standard. By using the levels of the security strength, the user can confirm at what security strength the information processing apparatus 100 is operated.

In the following, in some cases, the level is omitted from the level of the security strength. In these cases, it is simply described that the security strength is high, middle, or low.

When the user pushes (touches) the “SECURITY STRENGTH DESIGNATION” button on the top screen “a”, a third screen “c” is displayed. The third screen “c” receives a change of the level of the security strength. In the third screen “c”, the level of the security strength of the current system has been changed from “MIDDLE” to “HIGH”. That is, a security strength changing unit is realized. When the user pushes an “OK” button on the third screen “c”, the third screen “c” is changed to a fourth screen “d”.

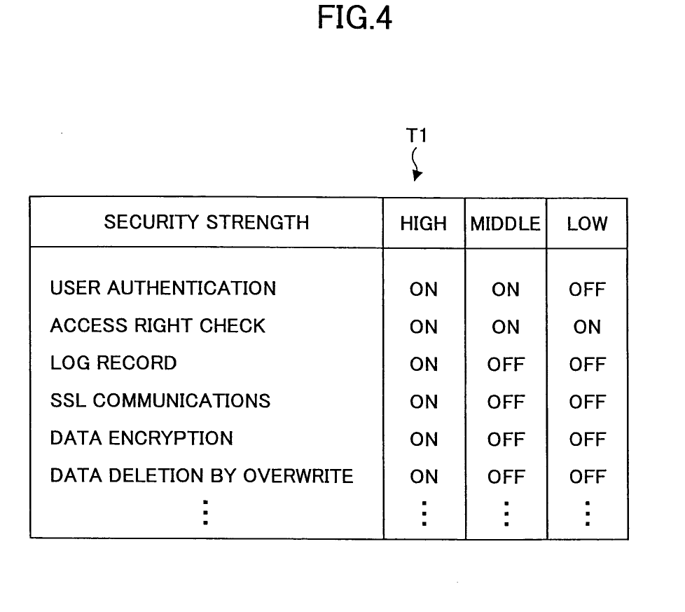

FIG. 4 is a first definition table T1 which defines a relationship between the security strength and the security function items. In FIG. 4, security function items of user authentication, access right check, log record, SSL communications, data encryption, and data deletion by overwrite are described in the relationship with the levels of the security strength. As described above, the value is ON or OFF.

As shown in the fourth screen “d”, since the level of the security strength of the current system is changed from “MIDDLE” to “HIGH”, by using the table T1, the values of the “LOG RECORD”, the “SSL COMMUNICATIONS”, and the “DATA ENCRYPTION” are changed from “OFF” to “ON”. That is, a setting changing and reporting unit is realized.

However, the values in the first definition table T1 can be arbitrarily changed; for example, the values of the log record can be nil for the security strength. With this, the security settings can be easily customized by a user request.

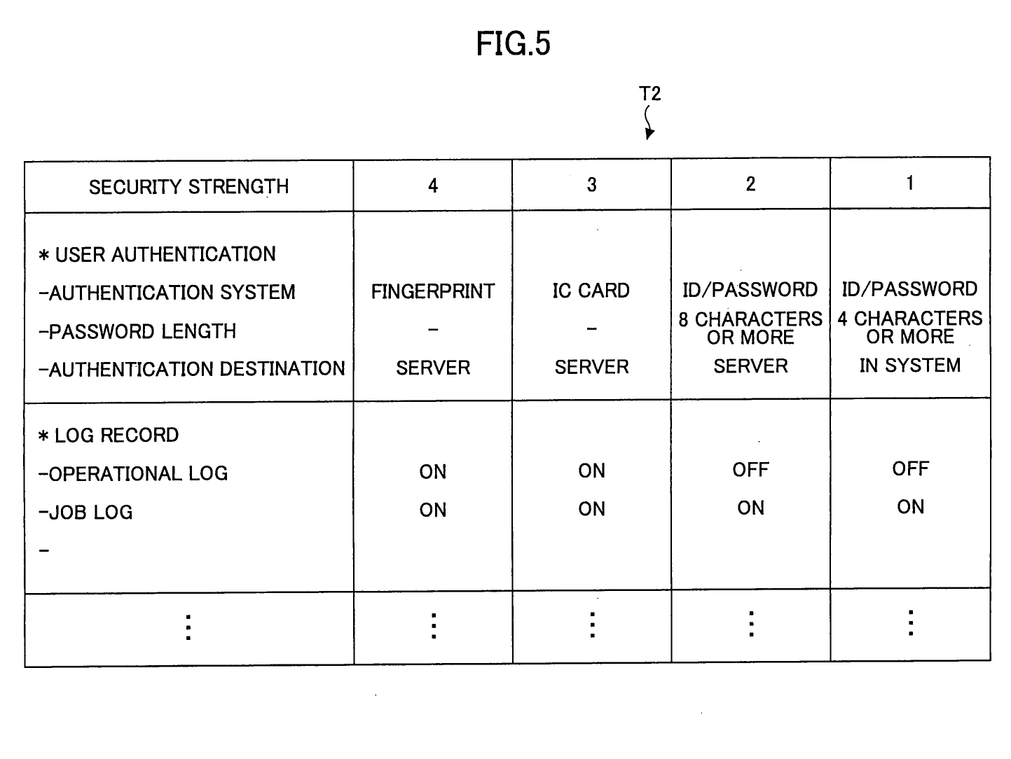

In addition, when the levels of the security strength are determined to have “n” steps (n >3), as shown in a second definition table T2 of FIG. 5, each security function item can be defined in more detail. FIG. 5 is the second definition table T2 which defines another relationship between the security strength and the security function items. In FIG. 5, as an example, the levels of the security strength have four steps 1 through 4, and, for example, the user authentication includes an authentication system, a password length, and an authentication destination; and the log record includes an operational log and a job log.

In the embodiment of the present invention, since the value (ON or OFF) of the security function items is defined corresponding to the levels of the security strength, when the user designates a level of security strength, the values of the corresponding security function items can be easily obtained by referring to the definition table T1 or T2. In addition, when a value of a security function item is changed, since the user can obtain notice of the changed value, the user can easily confirm the changed value of the security function item.

Returning to FIG. 3, when the user pushes (touches) the “USER AUTHENTICATION” button on the top screen “a”, a fifth screen “e” is displayed. The fifth screen “e” receives an instruction whether the user is to be authenticated. In the fifth screen “e”, as an example, the user authentication is changed from “ON” to “OFF”; that is, the user is not required to be authenticated. With this, a value change receiving and executing unit is realized. When an “OK” button is pushed on the fifth screen “e”, a sixth screen “f” is displayed. Since the user authentication is changed from “ON” to “OFF” in the fifth screen “e”, it is determined that the security strength is lowered, and a warning “SECURITY STRENGTH IS CHANGED” is displayed on the sixth screen “f”. With this, a security strength determining and reporting unit is realized. As described above, in the embodiment of the present invention, when a value of a security function item is changed from ON to OFF, it is determined whether the security strength is changed; when the security strength is lowered, a warning is displayed. Therefore, unintentionally lowering the security strength due to an operating error of the user can be prevented.

[Detail Description of Security Settings]

Next, the security settings are described in detail.

[Security Strength Check]

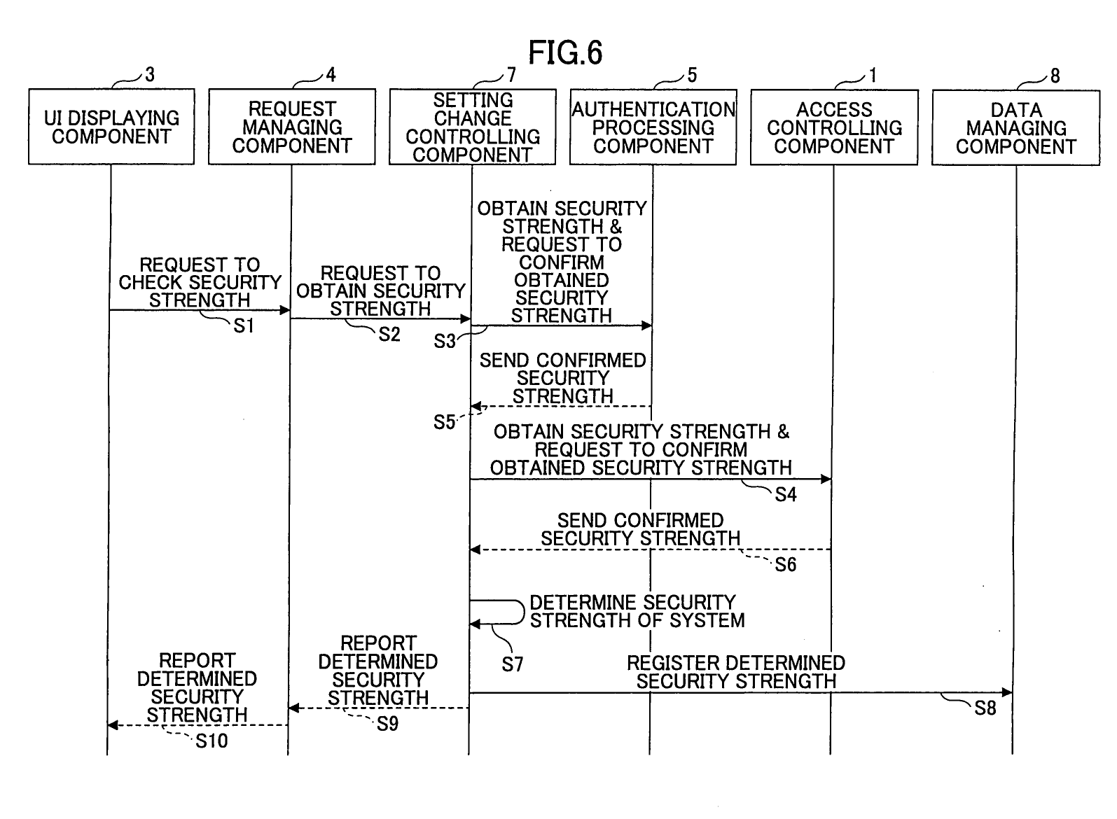

First, referring to FIGS. 3 and 6, the security strength check is described. In FIG. 6, as the components having corresponding security function items, the access controlling component 1 and the authentication processing component 5 are described as the examples. FIG. 6 is a sequence chart showing first processes in the security strength check.

First, when the “SECURITY STRENGTH CHECK” button is pushed on the top screen “a” of FIG. 3, the UI displaying component 3 receives an instruction of the security strength check and requests the request managing component 4 to check the security strength (S1). The request managing component 4 requests the setting change controlling component 7 to obtain security strength (status) (S2). The setting change controlling component 7 obtains the security strength and requests the authentication processing component 5 to confirm the obtained security strength (S3). The authentication processing component 5 confirms the security strength and sends the confirmed security strength to the setting change controlling component 7 (S5). In addition, the setting change controlling component 7 requests the access controlling component 1 to confirm the obtained security strength (S4). The access controlling component 1 confirms the security strength and sends the confirmed security strength to the setting change controlling component 7 (S6). The setting change controlling component 7 determines the security strength of the system of the information processing apparatus 100 (S7).

In the system of the information processing apparatus 100, the security strength is determined by the security strength sent from all of the security function items of the components. As security strength determining methods, the following first through fourth methods can be used.

[First Method]

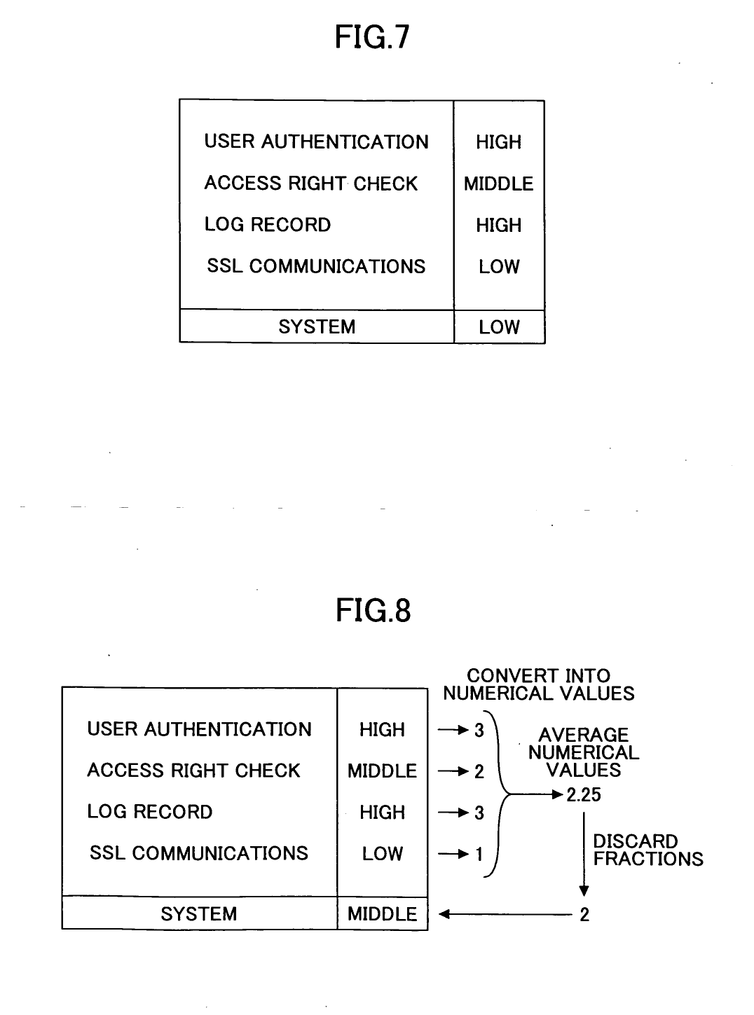

A lowest level in levels of security strength in all of the security function items of the components is determined to be the security strength of the system. FIG. 7 is a first table which is used by a first security strength determining method. As shown in FIG. 7, since the level of the security strength of the SSL communications is “LOW” which is the lowest level in the levels of the security strength of the security function items of the components, the security strength of the system is determined to be “LOW”. When the lowest level of the security strength in all of the security function items of the components is determined to be the level of the security strength of the system, the security strength of the system can be determined to be severe.

[Second Method]

An average level of levels in the security strength of all of the security function items of the components is determined to be the level of the security strength of the system. FIG. 8 is a second table which is used by a second security strength determining method. As shown in FIG. 8, each of the levels of the security strength of the security function items of the components is converted into a numerical value, and an average value is calculated from the numerical values of the security strength of the security function items of the components. By using the average value, the level of the security strength of the system is determined to be “MIDDLE”.

[Third Method]

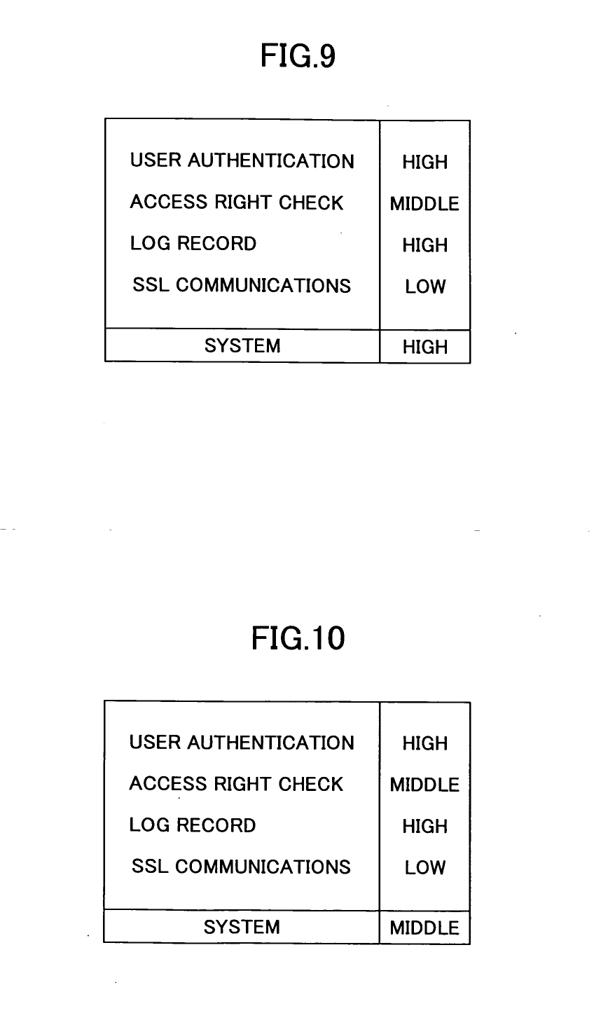

A most common level of levels of security strength in all of the security function items of the components is determined to be the level of the security strength of the system. FIG. 9 is a third table which is used by a third security strength determining method. As shown in FIG. 9, since the levels of the user authentication and the log record are “HIGH” which is the most common in the levels of the security strength, the level of the security strength of the system is determined to be “HIGH”.

[Fourth Method]

Important security function items of components are determined, and the level of the security strength of the system is selected from levels of the important security function items of the components. That is, weighting is applied to each security function item and one of the weighted security function item is selected. FIG. 10 is a fourth table which is used by a fourth security strength determining method. In FIG. 10, the security function items of the user authentication and the access right check are selected as the important security function items and the levels of the security strength of the system is determined from the levels of the security strength of the two selected security function items. In FIG. 10, the levels of the security strength corresponding to the access right check is “MIDDLE”, and the level of the security strength corresponding to the user authentication is “HIGH”; therefore, the level of the security strength “MIDDLE” of the access right check is determined to be the security strength of the system which “MIDDLE” is lower than “HIGH” of the security strength of the user authentication. In this case, when one of the levels of the security strength of the user authentication and the access right check is “LOW”, the level of the security strength of the system is determined to be “LOW”. When the weighting is applied to each security function items and the level of the security strength of the system is determined by the weighted security function items, the level of the security strength of the system can be easily customized.

Returning to FIG. 6, the setting change controlling component 7 causes the data managing component 8 to register the determined level of the security strength in a storage unit, for example, the MEM-C 117 and/or the HDD 118 (see FIG. 1) (S8). The setting change controlling component 7 reports the determined security strength to the request managing component 4 (S9), and the request managing component 4 reports the determined security strength to the UI displaying component 3 (S10). The UI displaying component 3 displays the second screen “b” and the user confirms the determined security strength of the current system.

As described above, the information processing apparatus 100 has the tables shown in FIGS. 7 through 10 which are used in the corresponding security strength determining methods; when one of the methods is selected, the security strength of the system can be automatically determined and the determined security strength can be displayed.

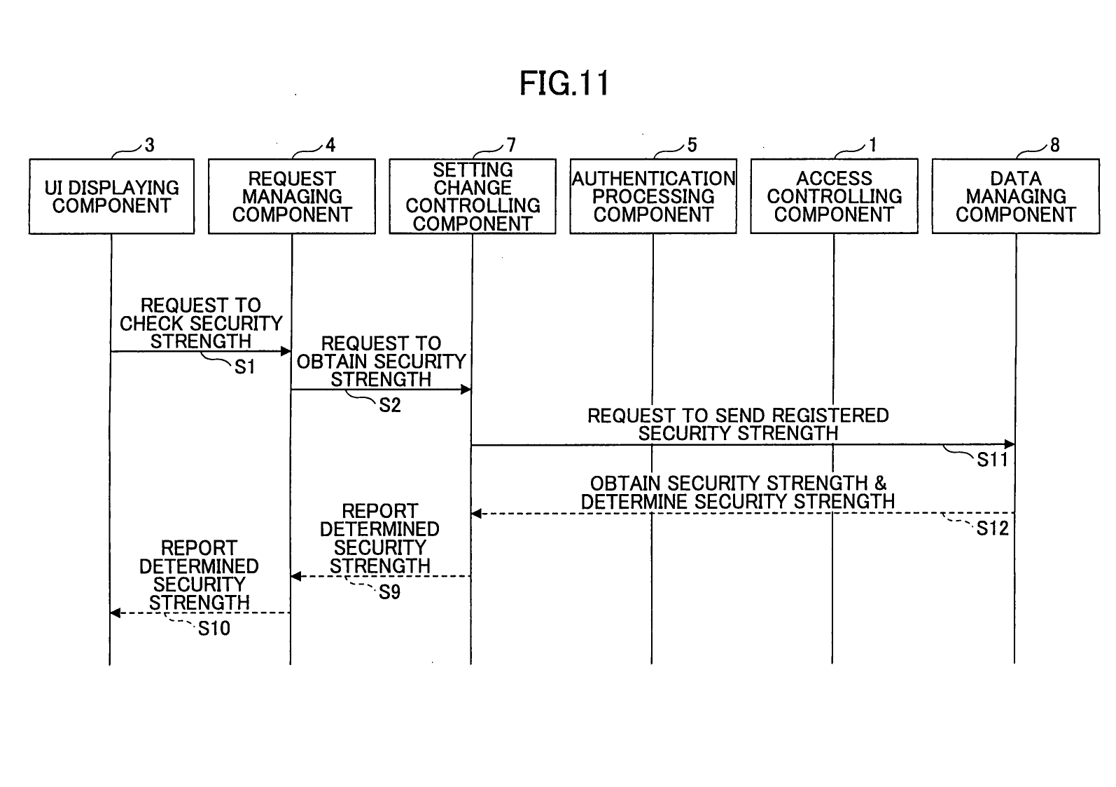

In the above, the security strength of the system is automatically determined from the levels of the security strength of the corresponding security function items of the components by using one of the security strength determining methods. However, when the security strength of the current system has been registered in, for example, the MEM-C 117 or the HDD 118, as shown in FIG. 11, the setting change controlling component 7 requests the data managing component 8 to send the registered security strength (S11), and directly obtains the security strength and determines the security strength (S12). FIG. 11 is a sequence chart showing second processes in the security strength check.

[Setting Change when Security Strength is Designated]

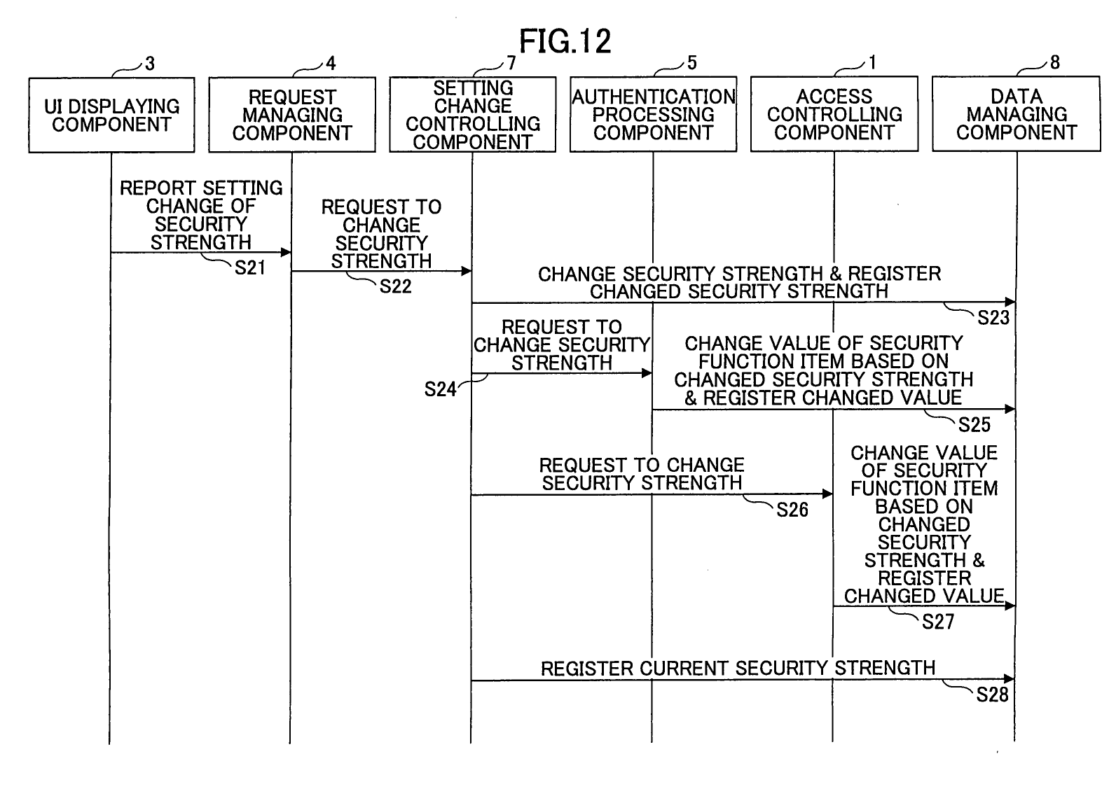

Next, referring to FIGS. 3 and 12, a setting change is described when security strength is designated. FIG. 12 is a sequence chart showing processes when the security strength is designated. In FIG. 12, as the components having corresponding security function items, the access controlling component 1 and the authentication processing component 5 are described as the examples.

First, when the “SECURITY STRENGTH DESIGNATION” button is pushed (touched) on the top screen “a” of FIG. 3, the UI displaying component 3 displays the third screen “c”. When the UI displaying component 3 receives a setting change while the level (HIGH, MIDDLE, or LOW) of the security strength is designated, the UI displaying component 3 reports the setting change of the security strength to the request managing component 4 (S21). In this case, as shown in FIG. 3, the security strength is designated to be “HIGH”; that is, the security strength is changed from “MIDDLE” to “HIGH”.

The request managing component 4 requests the setting change controlling component 7 to change the security strength (S22). The setting change controlling component 7 changes the security strength, and causes the data managing component 8 to register the (designated) changed security strength in a storage unit, for example, the MEM-C 117 or the HDD 118 (S23). In addition, the setting change controlling component 7 requests the authentication processing component 5 to change the security strength (S24). The authentication processing component 5 changes the value of the security function item based on the changed security strength by using, for example, the first definition table T1 shown in FIG. 4. The authentication processing component 5 causes the data managing component 8 to register the changed value of the security function item, and the data managing component 8 registers the changed value in a storage unit, for example, the MEM-C 117 or the HDD 118 (S25).

In addition, the setting change controlling component 7 requests the access controlling component 1 to change the security strength (S26). The access controlling component 1 changes the value of the security function item based on the changed security strength by using, for example, the first definition table T1 shown in FIG. 4. The access controlling component 1 causes the data managing component 8 to register the changed value in a storage unit, for example, the MEM-C 117 or the HDD 118 (S27).

Further, the setting change controlling component 7 sends the current security strength to the data managing component 8, and the data managing component 8 registers the current security strength in a storage unit, for example, the MEM-C 117 or the HDD 118 (S28).

In the above, the components having corresponding security function items, for example, the access controlling component 1 and the authentication processing component 5, have a table which describes a relationship between the security strength and the values of the security function items corresponding to the security strength. In addition, the setting change controlling component 7 has a list of components, for example, the access controlling component 1 and the authentication processing component 5, having corresponding levels for the security strength for the security function items.

As described above, in the embodiment of the present invention, when the level, for example, “HIGH” of the security strength is designated, the value (“ON” or “OFF”) of the security function items can be changed based on the designated security strength. Consequently, a user (manager) does not need to change each value one by one.

[Report of Security Strength Change when Value of Security Function Item is Changed]

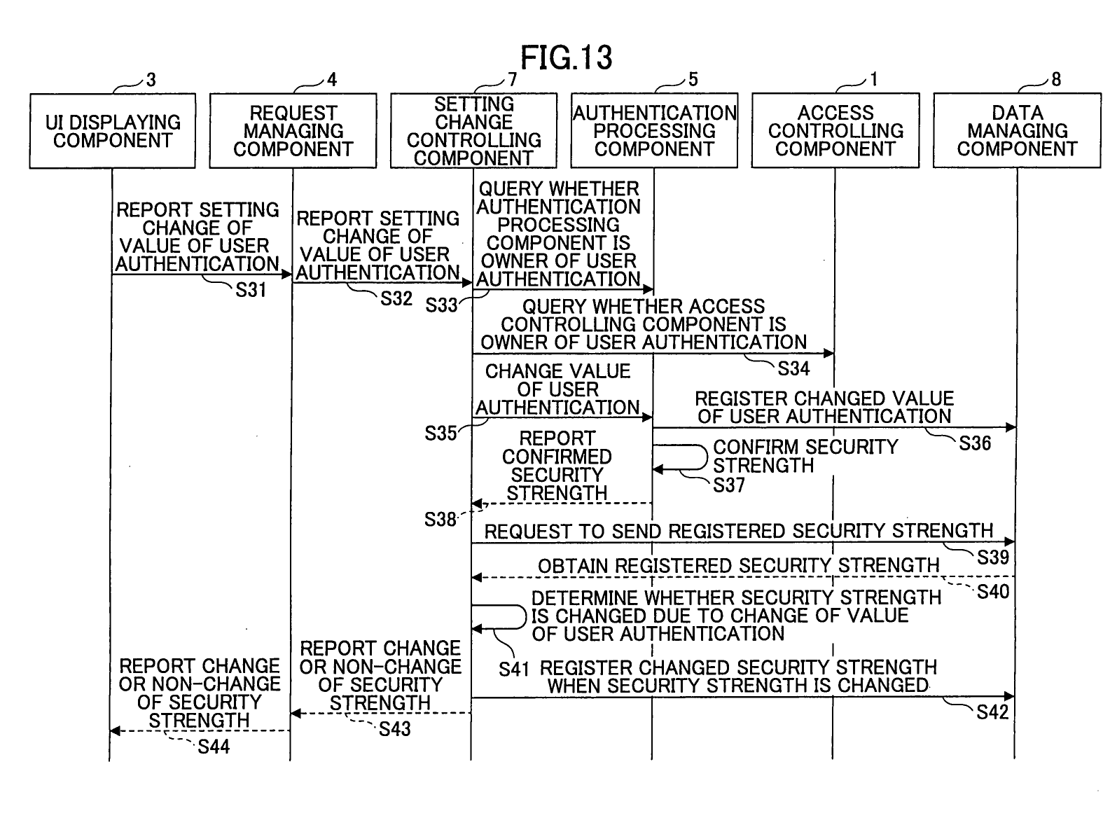

Next, referring to FIGS. 3 and 13, a report of a security strength change is described when a value of a security function item is changed. In this case, as an example, the user authentication is used as the security function item. FIG. 13 is a sequence chart showing processes when the value of the user authentication is changed. In FIG. 13, as the components having corresponding security function items, the access controlling component 1 and the authentication processing component 5 are described as the examples.

First, when the “USER AUTHENTICATION” button is pushed (touched) on the top screen “a” of FIG. 3, the UI displaying component 3 displays the fifth screen “e”. When the UI displaying component 3 receives a setting change of the value of the user authentication from ON to OFF, the UI displaying component 3 reports the setting change of the user authentication to the request managing component 4 (S31). The request managing component 4 reports the setting change of the value of the user authentication to the setting change controlling component 7 (S32).

The setting change controlling component 7 queries the authentication processing component 5 whether the authentication processing component 5 is an owner of the value of the user authentication (S33). In addition, the setting change controlling component 7 queries the access controlling component 1 whether the access controlling component 1 is an owner of the value of the user authentication (S34). Since the authentication processing component 5 is the owner of the value of the user authentication, the setting change controlling component 7 causes the authentication processing component 5 to change the value of the user authentication (S35). The authentication processing component 5 causes the data managing component 8 to register the changed value of the user authentication in a storage unit, for example, the MEM-C 117 or the HDD 118 (S36). The authentication processing component 5 confirms the security strength after changing the value of the user authentication (S37), and reports the confirmed security strength to the setting change controlling component 7 (S38). The setting change controlling component 7 requests the data managing component 8 to send the registered security strength (S39), and obtains the security strength (S40). The setting change controlling component 7 determines whether the security strength is changed due to the change of the value of the user authentication (S41). The setting change controlling component 7 causes the data managing component 8 to register the changed security strength in a storage unit, for example, the MEM-C 117 or the HDD 118 when the security strength has been changed (S42).

The setting change controlling component 7 reports a change or a non-change of the security strength to the request managing component 4 (S43). The request managing component 4 reports the change or the non-change of the security strength to the UI displaying component 3 (S44). In this case, the value of the user authentication has been changed from “ON” to “OFF”, the UI displaying component 3 displays the sixth screen “f”.

In the above, in order to obtain to which component a security function item whose value is changed belongs, the components are queried. However, when a component, for example, a security function item defining component in which a relationship between security function items and corresponding components are defined is provided, the setting change controlling component 7 can obtain the component to which the security function item belongs by referring to the security function item defining component. In this case, the security function item defining section replies, for example, with a component ID of the component corresponding to the security function item to the setting change controlling component 7.

As described above, when a user changes a value of a security function item and the security strength is changed due to the changed value, the change of the security strength is reported to the user. That is, a unit for determining whether the security strength is changed is provided when a value of a security function item is changed. Therefore, it can be prevented that the security strength is unintentionally lowered due to an operating error of the user.

[Addition of New Component Having Security Function Items by Plug-in Program]

According to the embodiment of the present invention, when a new component having security function items is desired to be added in the information processing apparatus 100, a plug-in program is installed in the information processing apparatus 100.

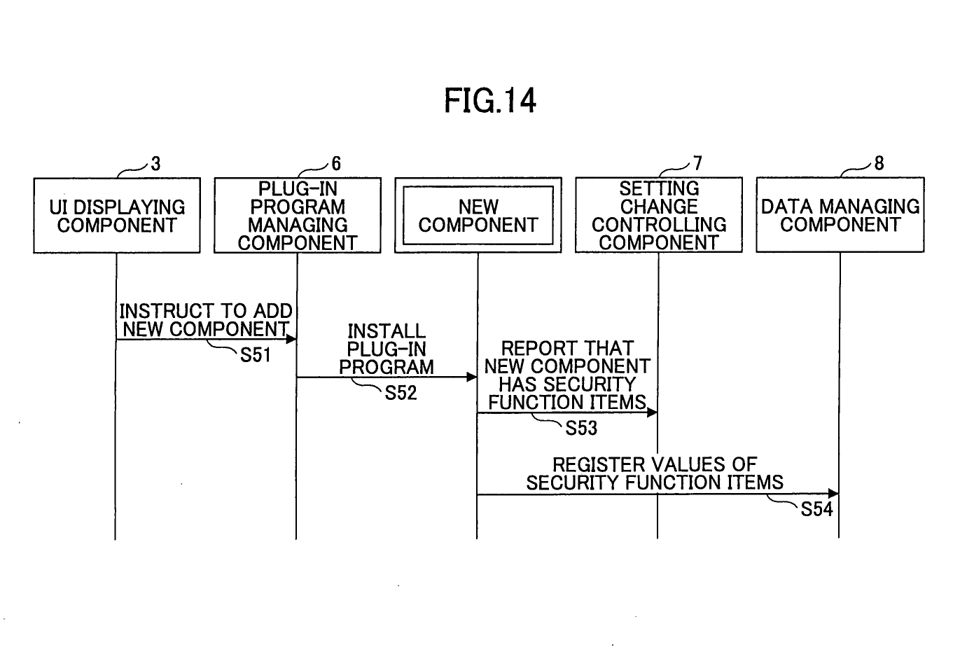

Referring to FIG. 14, processes are described when a new component having security function items is added to the information processing apparatus 100 by installing a plug-in program. FIG. 14 is a sequence chart showing the processes when the new component having the security function items is added to the information processing apparatus 100 by installing the plug-in program.

First, the UI displaying component 3 displays a screen where a new component having security function items is added, and a user instructs to add the new component on the screen (S51). The plug-in program managing component 6 receives the instruction and installs a plug-in program corresponding to the new component (S52). That is, a plug-in program installing unit is realized.

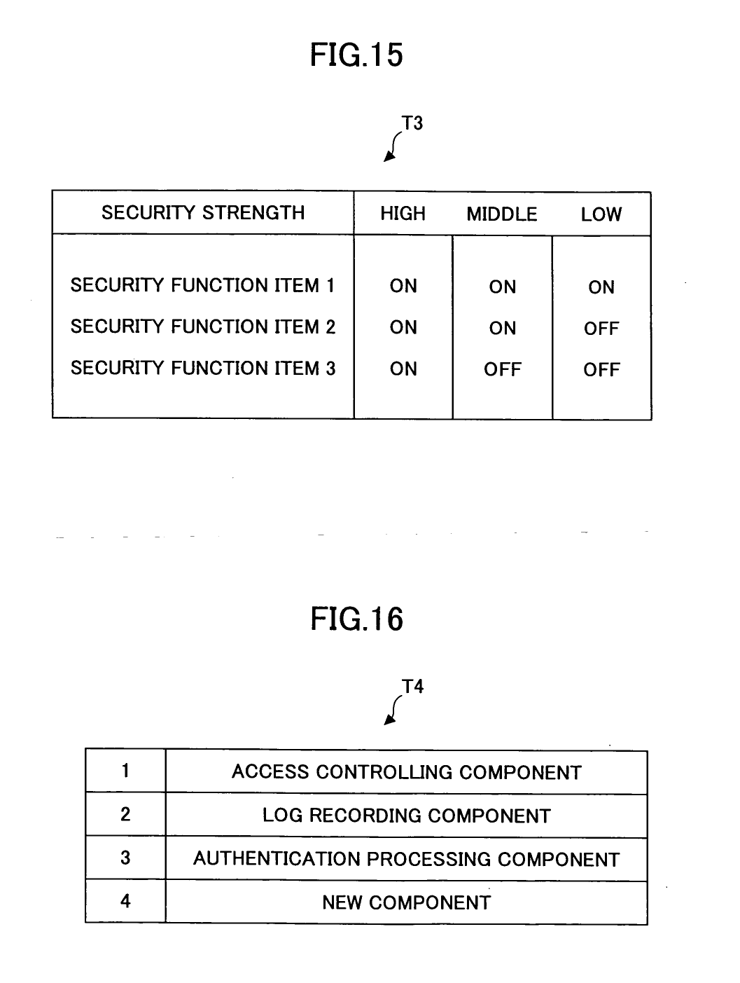

FIG. 15 is a table T3 which describes a relationship between security strength and security function items having corresponding values of a new component. The new component reports that the new component has security function items to the setting change controlling component 7 (S53). In addition, the new component causes the data managing component 8 to register the values of the security function items in a storage unit, for example, the MEM-C 117 or the HDD 188.

FIG. 16 is a table T4 showing a list of components having corresponding security function items in the setting change controlling component 7. As shown in FIG. 16, the new component is added to the list. In FIG. 16, the number does not correspond to the reference number of each component, and the number is a number in the list.

As shown in FIG. 15, the new component has the table T3 in which the relationship between the security strength and the security function items having corresponding values is described. Therefore, when the new component is added in the information processing apparatus 100 by installing the plug-in program, the security strength of the information processing apparatus 100 can be displayed without changing an existing program (software).

Further, the new component can have plural security function items and each security function item has a value (ON or OFF) corresponding to the level of the security strength. Therefore, when the new component is added to the information processing apparatus 100, the value of the security function item in the new component can be changed by an instruction of the security strength without changing an existing program (software).

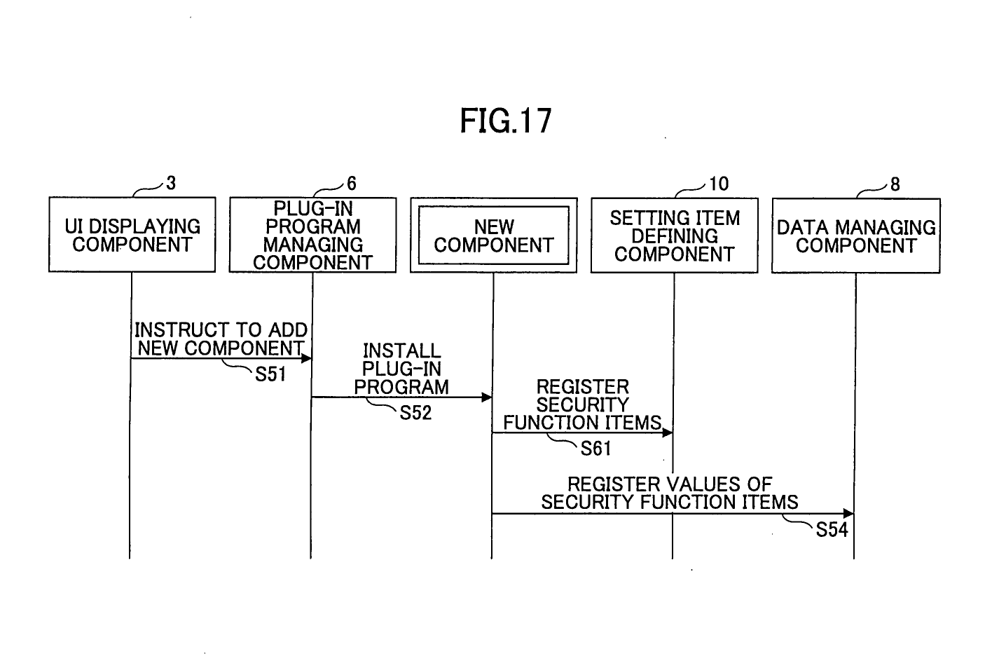

In FIG. 14, the new component reports that the new component has the security function items to the setting change controlling component 7. However, as shown in FIG. 17, when a setting item defining component 10 is provided, the security function items of the new component can be registered in the setting item defining component 10 (S61). FIG. 17 is a sequence chart modified from the sequence chart shown in FIG. 14 when the setting item defining component 10 is added to the information processing apparatus 100.

Further, the present invention is not limited to the specifically disclosed embodiment, and variations and modifications may be made without departing from the scope of the present invention.

The present invention is based on Japanese Priority Patent Application No. 2007-148430, filed on Jun. 4, 2007, with the Japanese Patent Office, the entire contents of which are hereby incorporated herein by reference.

What is claimed is:

1. An information processing apparatus, comprising:
a defining unit which defines a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system;
a security strength change receiving unit which receives a change of the security strength step by step; and
a first value changing unit which changes a value of a security function item of a component by referring to the relationship defined by the defining unit when the security strength change receiving unit receives the change of the security strength.

2. The information processing apparatus as claimed in claim 1, further comprising:
a plug-in program installing unit which installs a plug-in program of a new component for adding a new security function item to the information processing apparatus; wherein
the new component includes information of a relationship between the security strength of the computer system and a value of the new security function item of the new component.

3. The information processing apparatus as claimed in claim 1, further comprising:
a value change receiving unit which receives a change of the value of the security function item of the component;
a second value changing unit which changes the value of the security function item of the component based on the change of the value received by the value change receiving unit;
a determining unit which determines whether the security strength of the computer system is changed due to the value changed by the second value changing unit; and
a change reporting unit which reports the change of the security strength when the determining unit determines that the security strength is changed.

4. The information processing apparatus as claimed in claim 1, further comprising:
a security strength confirmation receiving unit which receives a request of confirming the security strength of the computer system;
a security strength determining unit which determines the security strength of the computer system based on the security strength of the security function item; and
a security strength reporting unit which reports the security strength of the computer system based on the security strength determined by the security strength determining unit.

5. The information processing apparatus as claimed in claim 4, wherein:
the security strength determining unit determines the security strength of the computer system to be lowest security strength of the security strength of the security function items.

6. The information processing apparatus as claimed in claim 4, wherein:
the security strength determining unit determines the security strength of the computer system to be average security strength of the security strength of the security function items.

7. The information processing apparatus as claimed in claim 4, wherein:
the security strength determining unit determines the security strength of the computer system to be most common security strength of the security strength of the security function items.

8. The information processing apparatus as claimed in claim 4, wherein:
the security strength determining unit determines the security strength of the computer system to be one security strength by weighting the security strength of the security function items.

9. The information processing apparatus as claimed in claim 1, further comprising:
a reporting unit which reports the value of the security function item changed by the first value changing unit.

10. An information processing method in an information processing apparatus, comprising the steps of:
defining a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system;
receiving a change of the security strength step by step; and
changing a value of a security function item of a component by referring to the relationship when the change of the security strength is received.

11. The information processing method as claimed in claim 10, further comprising the step of:
installing a plug-in program of a new component for adding a new security function item to the information processing apparatus; wherein
the new component includes information of a relationship between the security strength of the computer system and a value of the new security function item of the new component.

12. The information processing method as claimed in claim 10, further comprising the steps of:
receiving a change of the value of the security function item of the component;
changing the value of the security function item of the component based on reception of the change of the value;
determining whether the security strength of the computer system is changed due to the change of the value; and
reporting the change of the security strength when the security strength is changed.

13. The information processing method as claimed in claim 10, further comprising the steps of:
receiving a request of confirming the security strength of the computer system;
determining the security strength of the computer system based on the security strength of the security function item; and
reporting the security strength of the computer system based on the determined security strength.

14. The information processing method as claimed in claim 10, further comprising the step of:
reporting the value of the security function item when the value of the security function item is changed.

15. A computer-readable recording medium storing an information processing program in an information processing apparatus, wherein:
the information processing program executes the steps of
defining a relationship between security strength that is a degree of countermeasures against vulnerability of a computer system of the information processing apparatus or a degree of countermeasures against a threat from the outside to the computer system and values of security function items of corresponding components that prevent or avoid the vulnerability of the computer system and the threat from the outside to the computer system;
receiving a change of the security strength step by step; and
changing a value of a security function item of a component by referring to the relationship when the change of the security strength is received.

16. The computer-readable recording medium storing the information processing program in the information processing apparatus as claimed in claim 15, wherein:
the information processing program further executes the step of
installing a plug-in program of a new component for adding a new security function item to the information processing apparatus; wherein
the new component includes information of a relationship between the security strength of the computer system and a value of the new security function item of the new component.

17. The computer-readable recording medium storing the information processing program in the information processing apparatus as claimed in claim 15, wherein:
the information processing program further executes the steps of
receiving a change of the value of the security function item of the component;
changing the value of the security function item of the component based on reception of the change of the value;
determining whether the security strength of the computer system is changed due to the change of the value; and
reporting the change of the security strength when the security strength is changed.

18. The computer-readable recording medium storing the information processing program in the information processing apparatus as claimed in claim 15, wherein:
the information processing program further executes the steps of
receiving a request of confirming the security strength of the computer system;
determining the security strength of the computer system based on the security strength of the security function item; and
reporting the security strength of the computer system based on the determined security strength.

19. The computer-readable recording medium storing the information processing program in the information processing apparatus as claimed in claim 15, wherein:
the information processing program further executes the step of
reporting the value of the security function item changed when the value of the security function item is changed.
